(19) United States
(12) Patent Application Publication
(10) Pub. No.: US 2001/0002984 A1
(43) Pub. Date: Jun. 7, 2001

(54) Reactor support comprising a plurality of micro-sample receiving chambers

(75) Inventor: Dirk Vetter, Freiburg (DE)

Correspondence Address: Jordan and Hamburg, 122 East 42nd Street, New York, NY, 10168, US

(73) Assignee: Graffinity Pharmaceutical Design GmbH

(21) Appl. No.: 09/735,724

(22) Filed: Dec. 11, 2000

(30) Foreign Application Priority Data
Jun. 10, 1998 (DE) 198 25 909.3

(51) Int. Cl. B01L 3/00

(52) U.S. Cl. 422/102; 422/130

(57) ABSTRACT

The invention relates to a reactor support comprising a plurality of micro sample accommodating chambers which is especially used in automated laboratory operations in the field of combinatorial chemistry. The aim of the invention is to provide such a reactor support which enables individual sample accommodating chambers to be loaded with sample particles in a simple manner, and above all which permits a simultaneous reproducible liquid filling of all sample accommodating chambers or of a part of the sample accommodating chambers, said part being selectable in a defined manner, without additional pipetting steps. To this end, recesses are provided in a plate. A shaped body is fitted into each recess. Said shaped body is provided with a recess which is open on one side and which is provided for accommodating a plurality of sample particles. In addition, the shaped body is constructed such that it is porous in all wall areas and is fitted into each recess such that the shaped body with the side of the opened recess thereof terminates in a flush manner with a first surface of the plate or is inserted in the same such that it is moved back. The shaped part projects with the remaining part thereof from the second surface of the plate. Said projecting part can only be brought into contact with liquid feeding means at least in the base area thereof.

### BACKGROUND OF THE INVENTION

The invention relates to a reactor support comprising a plurality of micro-sample receiving chambers that is particularly for use in automated laboratory work in the field of combinatorial chemistry.

Reaction vessels, in which sample particles in the form of beads are used for the separation and synthesis in the laboratory technological field, have been known for years. Mostly, there are glass or polymeric globules concerned that have diameters of 0.01 mm up to 1 mm, typically about 0.1 mm, and that are filled, dry or pre-swelled, as a loose material into a reaction vessel and then are flushed by a liquid, whereby an adsorption process or a reaction process takes place between the solid phase surface of the particles and the liquid surrounding the particles (refer to, for example, U.S. Pat. No. 5,437,979). Methods of the column chromatography, for example, gel filtration, of the column extraction, of the immundiagnosis, of the bio-molecule purification, for example, DNA cleaning, as well as of the homogeneous and heterogeneous synthesis, for example, of oligonucleotides, peptides or combinatorial substance libraries, utilize these techniques.

In addition to the automation and miniaturizing of laboratory techniques, the parallelizing of the same is of great interest in obtaining a higher sample throughput and, hence, to accelerate otherwise time-consuming procedures. To this end, samples are very often arranged in a raster so that the identity (origin, quality) of the sample can be connected to an area coordinate. Such coordinates are very easily to be detected in particular in automated systems of sample handling.

Therefore, so-called micro-titer plates have been developed for liquid samples, which support right-angular arrangements of 8-12 (96), 16-24 (384) or 32-48 (1536) cavities. Thereby, the dimensions of the cavities of these sample holders depend on such volumes that can be reliably dosed by the commercially available devices (pipettes), and follow a miniaturizing continuously progressing with the dosing technology.

Usually, the sample particles mentioned are brought to reaction in sample receptacles that are provided with filter bottoms, with the walls of the sample receptacles being impermeable to the liquids used and the particles being held on the filter. Liquids are charged from top and after the transfer has been completed, they are pressed through the filter bottom, sucked off or are permitted to drain. This requires a liquid transfer operation step; the liquids have to be taken from the cavities and have to be filled into the particle receptacles. Conventionally, manual pipettes or pipetting automates are employed to this end.

The transfer of the liquids from the micro-titer plate cavities into the receptacles for the sample particles very often meets difficulties. This, in particular, becomes obvious with sample supports, which are highly miniaturized. Due to the high time requirements, the pipetting in single steps is not any more practicable with raster arrangements containing more than 100 samples. Instead of this, automatic pipettes are utilized that are adapted to aspirate and dispense in a multi-parallel manner. Such automates have, for example, 96 simultaneously working pipette-like piston-stroke devices. It is, however, a disadvantage that the geometry and the measures of the raster of the pipetting device very often do not correspond to the sample pattern and to that of the sample receptacle, respectively. This, in particular, is valid with new and especially densely packed raster formats. This problem, however, can be avoided in those special cases in which the dimensions of the raster of the pipetting device and of the sample supports are integer multiples, in that the pipetting robot serially processes multi-fillings. Thus, for example, sixteen conventional micro- titer plates containing 96 liquid samples can be rearranged on a miniaturized titer-plate of 1536 cavities in sixteen transfer steps. Here again, however, a loss of time has to be accepted, which can involve unfavorable effects with reaction kinetically sensitive transfers. Apart from the above-described technical solutions, further micro-titer plates and devices, respectively, which are to be brought into micro-titer plates, are known.

Thus, in EP 0 269 415 A2 a titer plate is described that is provided with inserts of bio-chemically compatible micro-porous surfaces, to which biological material can be bound. The structural design of these inserts is there provided with the intention to adapt the titer plate for insertion into a spectrometer.

The U.S. Pat. No. 5,417,923 discloses an arrangement for receiving a plurality of samples, whereby the arrangement consists of a test plate and a collecting plate. Thereby the test plate contains chambers, which are filled with a chromatographic material sandwiched between two fritted glass filters.

In WO 96/39250 A1 a filtration device is described that is provided with hole containing side walls pre-positioned by membrane filters, whereby the bottom range of the receptacles provided in said range is expressly kept free of filter bodies to eliminate a slowing-down of the filtration by a barrier on the membrane.

WO 93/00420 A1 discloses a device for treating tissue cultures, which contains, inter alia, a filter plate into which vessels can be introduced that have a closed wall area and a bottom area provided with a filter. Furthermore, means are provided that bring about a positioning of the bottom areas of the vessels relative to the titer plate in order to minimize capillary forces.

DE 91 00 320 U1 describes a micro-test plate comprising a plurality of receiving chambers, into which pins arranged on a pin-plate can be inserted. The pins are loaded with antigens and allergens, respectively, or the like, and the arrangement of the same on the pin plate corresponds to the arrangement of the receiving chambers on the micro-test plate.

A further titer plate is described in DE 33 36 738 A1 that is provided with separately exchangeable inserts adapted for receiving cones, which are arranged, comparable to DE 91 00 320 U1, on a further plate so that an arrangement results that is also closed on all sides.

Finally, a device for tissue cultures can be read from WO 94/28111 A1 that also has a plurality of inserts, which are provided with laterally closing walls and with a porous bottom. This solution compares to the above-cited WO 93/00420 A1.

The above described devices have features also contained in the present reactor support. They are, however, not suited in solving the objects stated hereinafter.

### SUMMARY OF THE INVENTION

It is an object of the present invention to provide a reactor support comprising a plurality of micro-sample receiving chambers, said reactor support, in a simple way, permits to charge the single sample receiving chambers with sample particles and, above all, a simultaneous reproducible filling of all sample receiving chambers with liquids or a definitely selectable part of sample receiving chambers without additional pipetting steps, as common with the prior art.

The object is realized by a reactor support having the features of the claim 1. Advantageous embodiments are subject of the dependent claims.

### DETAILED DESCRIPTION OF THE INVENTION

In the following, the reactor support will be explained in more detail by virtue of schematical embodiments. There is shown in:

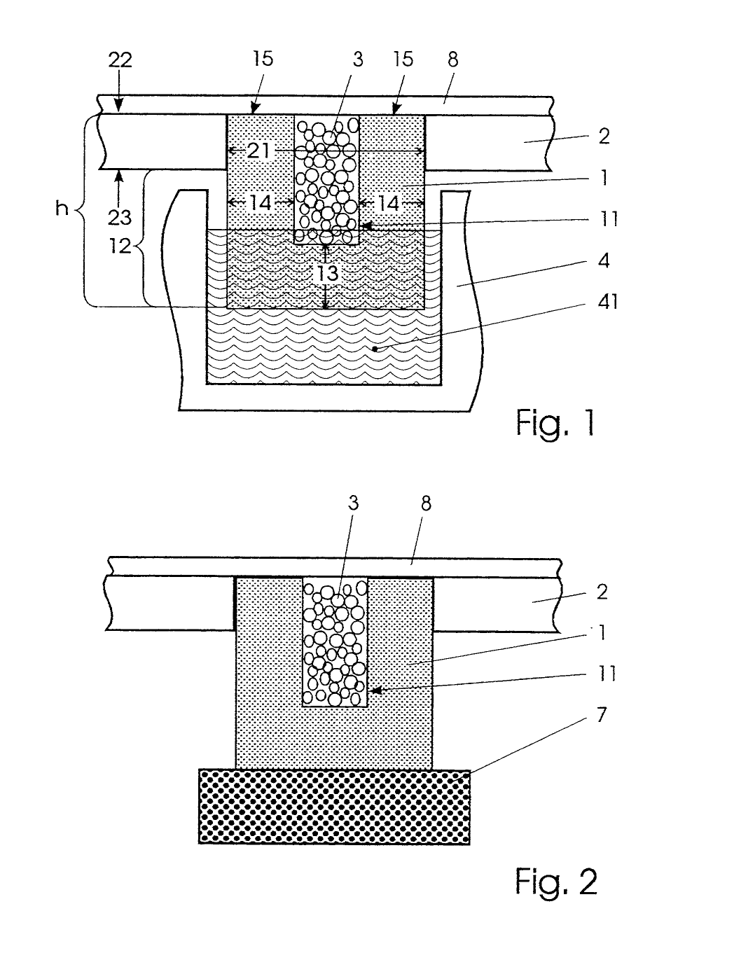

FIG. 1 a sectional view of a detail of a reactor support comprising an inserted porous shaped body and a first way of charging liquids;

FIG. 2 a sectional view of a detail of a reactor support according to FIG. 1 exhibiting a second way of charging the shaped body with liquids;

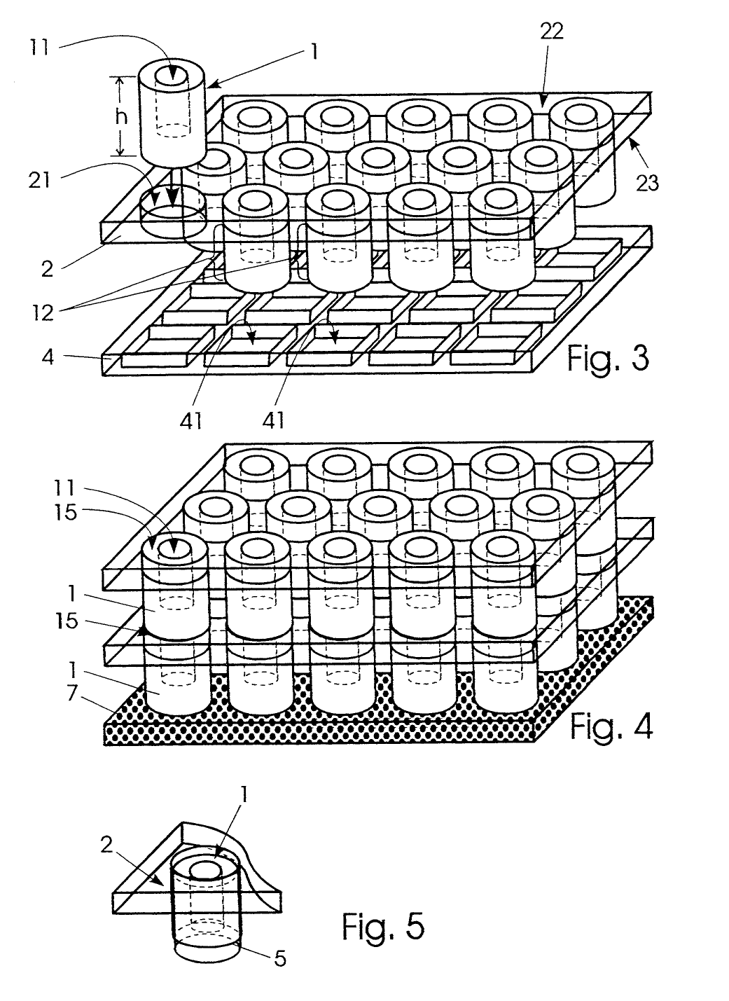

FIG. 3 a perspective view of a detail of a reactor support comprising a plurality of inserted shaped bodies;

FIG. 4 a perspective view of a possible stacking of reactor supports that are provided with shaped bodies; and

FIG. 5 a further possibility of inserting a shaped body into the reactor support.

The difficulties that are involved with the prior art with respect to rearranging liquid samples, are avoided in that a specially shaped body 1 is used which is shown in section in FIG. I with its substantial features. Recesses 21 are inserted into a plate 2, only a detail of which being represented in FIG. 1. Said recesses 21 are adapted to receive and to mount the shaped body 1. Thereby, the shaped body 1 is inserted into the plate 2 in such a way that the upper annular rim 15 of the shaped body 1 is flush with the first plate surface 22 or is inserted slightly set back, that is, recessed, whereas it projects beyond the second plate surface 23 by its remaining portion 12. In particular, the projecting portion 12 takes at least half the height h of the shaped body. As to the shaped body 1, all its wall areas, comprising the side walls 14 and the bottom area 13, are porously designed and the shaped body I itself has a central recess 11, into which a plurality of sample particles 3 are provided. When, by lowering the plate 2, the shaped body 1 is immersed into a liquid filled vessel 4, then the shaped body 1 is definedly filled with the liquid in a passive way from bottom and via the side walls 14 of the shaped body, respectively. Thereby, the porosity of the shaped body 1 as well as the diameter distribution of the packed particles inserted into the recess 11 is so determined that the rising of the liquid within the shaped body is substantially effected by the capillary forces.

Simultaneously, the walls of the shaped body act as filters at a respective dimensioning of the porosity.

Preferably, porous materials based on plastics are used for the shaped body 1. Such materials are produced out of a granulated material on the basis of polyethylene, polypropylene or polytetrafluoroethylene by a sintering process at about 150° C. However, porous glass or silicon, ceramics or metal frits can also be used. When there is sufficient liquid for filling supplied in a cavity 41, a complete defined filling of the recess 11 is obtained already after a time of 0.1-10 s, at a pore size of 1-250 μm (18-40 μm in the example), a porosity (percentage of the pore volume at the entire volume) of the shaped body used in the frame of the invention in a range of from 5-75%, (35% in the example), and a porosity of the packed sample particles provided in the recess 11 of 5-95% (50% in the example), and at a mean diameter distribution of the sample particles in an order of size of 5-500 μm. The taken up quantity of liquid is defined by the entire pore volume of the shaped body. This means that the filling operation is highly reproducible; a vessel formed by the shaped body always takes a same quantity of liquid.

The interior of the recess 11 thereby is homogeneously filled with sample particles 3. Advantageously, the diameters of the particles are designed greater than the pores in the walls 14 and the bottom 13. Due to the loose filling and the narrow packing of the particles, capillary forces become effective also within the reaction vessel at the supply of liquids. In the course of filling with liquids, the recess 11 will be well-definedly filled up to its upper annular rim 15, at a suitable ratio of the volumes between the particles 3 holding recess 11 of the shaped body 1 and its porous walls, whereby the walls have to be preferably given a greater volume that is, in particular, determined in an order of size of 0.1-100 μm. In this way the placed particles 3 are not only completely wetted, but also transferred with a precisely definable volume, when there is an excess of liquid reagent. This considerably facilitates the control of the reaction course compared to the prior art. The reaction sequences turn out as easily controllable since the quantity of reagents in solution can be exactly measured. The aliquoting and the measuring, respectively, of the quantity of liquids will be defined by the volume of the porous shaped body 1 and does not require any pipetting techniques, which unavoidably involve fluctuations when the filling operation is repeated. The variability between the single shaped bodies, which will directly affect the volume to be received, is low, since the geometrical deviations are minimal due to a precision mechanical manufacture of the shaped bodies, being subject to a preceding quality control, and since they cannot change from one filling step to the next one.

The micro-reaction vessels formed by the shaped bodies 1, which in the example have a height h of 3.1 mm and an outer diameter of 1.75 mm, are provided with the recesses 11, which are open towards their top, to ensure that the sample particles are inserted in loose form simply by pouring. After filling, the excess particles are removed and the entire reactor support and preselectable parts thereof, respectively, can be closed by a cover 8, particularly formed by a foil, more particular by a self-adhesive foil. Here a further advantage of the invention becomes obvious: even when the top side of the reactor is covered by a cover 8 and parts of the side wall 14 of the shaped body are covered by the recess 21 or by a wall impermeable by liquids, such as a shell 5 (refer FIG. 5) inserted into the recess 21, the self-filling still completely takes place from bottom and captures the entire reactor volume. This is not possible by the common prior art vessels with massive walls, such as, for example, capillary elements or tubes, since air pockets prevent the rising of the liquid.

FIG. 3 shows a perspective view of a transparently represented detail of a plate 2 comprising a plurality of inserted shaped bodies 1. In the present example, the insertion of the shaped bodies 1 in the recesses 21 and the arrangement thereof is carried out in such a way that their positioning corresponds to the distribution of cavities 41 of a micro-titer plate constituted of vessels 4. Reactor supports including such shaped bodies 1, which can be passively filled, can be directly put onto the vessels 4 of the micro-titer plate filled with liquids without the necessity of using any expensive automation techniques. The liquids formed of a plurality of samples provided in the micro-titer plate simultaneously rise in and into the shaped bodies 1, which are employed as reaction vessels, and wet the particles 3 held there, whereby exactly one reaction vessel takes a liquid from one cavity. Thereby, the outer diameter of the particle receptacles is selected smaller than the inner diameter of the cavities so that the shaped bodies 1, in which the desired reaction shall take place, can be inserted into the cavities and can contact the liquids provided therein.

It also lies in the scope of the invention, to ensure a liquid supply, instead via liquid-filled cavities of micro-titer plates, in that porous structures 7 are provided, which are soaked with a liquid or transport the same. Said structures 7 are designed complementary to the bottom range of the shaped bodies. In FIG. 2 such a structure 7 is indicated each associated to only one shaped body, at otherwise identical relations as in FIG. 1. In FIG. 4 this structure is represented as a continuously designed structure 7 that captures the entire bottom ranges of the shaped bodies. The fitting precision in the contact range ensures an effective liquid transfer by capillary forces for each design of the structure 7. Filter paper or structurized porous plastics, glass or ceramics can be used for such a liquid-transferring structure. Moreover, as can be seen in FIG. 4, a plurality of identically designed plates 2 can be stacked one above the other, whereby the liquid transfer takes place from the lower shaped bodies into the shaped bodies of the next level again by capillary force via the upper annular rim 15 of each shaped body 1. Such stacks of plates 2 can be reasonably used in highly parallel processes, as they are common use in the combinatorial chemistry.

The outstanding advantage of micro-structurized porous structures 7 correspondingly prepared for dispensing liquids is the possibility of the latter for a combinatorial charging. Hereby, ranges of a plate 2, which support the shaped bodies 1 as reaction vessels, are wetted with different liquid samples simultaneously or in sequence. The use of suitably cut or structurized liquid dispensers results in that a transitional area is created that enables a self-filling only in those areas which are selected for it. So, for example, the reaction vessels on a square reactor support in a 96×96 raster can be alternately wetted in a line-by-column pattern with 96 different liquids each by virtue of a filling structure designed in a longitudinal stripe. This “orthogonal” called liquid distribution is usual in the combinatorial chemistry, for example, in the synthesis of substance libraries.

Surface ranges of the shaped bodies, which are not to be used as contact areas for the liquid supply, can be covered by walls impermeable by liquids. FIG. 5 shows a sectional view of a detail of a further embodiment for inserting a shaped body into the plate 2, in which at first a shell 5 is inserted into the recesses 21 of the plate 2. The shell, in turn, receives the one shaped body 1 in such a way that a liquid supply is only ensured via the bottom range of the shaped body.

List of reference numerals

1- shaped body

11- recess in the shaped body 1

12- projecting portion (shaped body portion projecting beyond the second plate surface)

13- bottom area of the shaped body 1

14- side walls of the shaped body 1

15- upper annular rim of the shaped body 1

2- plate

21- recess in the plate 2

22- first plate surface (first surface of plate 2)

23- second plate surface (second surface of plate 2)

3- sample particles

4- vessel for liquids (micro-titer plate)

41- cavity

5- shell

7- porous structures as liquid dispensers

8- cover

1. Reactor support comprising a plurality of micro-sample receiving chambers, in which a plurality of sample particles in the form of flowable micro-bodies is received, characterized in that recesses (21) are provided in a plate (2), said recesses (21) are provided each with a shaped body (1), said shaped body being provided with a one-sidedly open recess (11) adapted for receiving a plurality of sample particles (3), all wall ranges (13, 14) of said shaped body (1) are rendered porously, said shaped body (1) being fitted into said recesses (21) in such a way that the side of its open recess (11) is flush with a first surface (22) of the plate (2) or is inserted into and slightly set back relative to said first surface (22), and by its remaining portion (12) projects beyond the second plate surface (23) of the plate (2), and exclusively this projecting portion (12) at least via its bottom area is adapted to be brought into contact with liquid supplying means (4, 41; 6), whereby the recesses (11) of the shaped body (1) can be closed by a cover (8).

2. Reactor support as claimed in claim 1, characterized in that said portion (12) of said shaped body (1) projecting beyond the second plate surface (23) of the plate (2) takes at least half the entire height (h) of the shaped body.

3. Reactor support as claimed in claim 1 or 2, characterized in that the bottom areas (13) and/or the side walls (14) are exclusively adapted for use in filling the shaped body (1) with a liquid.

4. Reactor support as claimed in one of the claims 1 to 3, characterized in that the recesses (21) of the plate (2) and, hence, the shaped body (1) are arranged corresponding to the cavities (41) of an attachable liquid receptacle pattern, for example, a micro-titer plate.

5. Reactor support as claimed in one of the claims 1 to 4, characterized in that the porosity of the shaped body (1) is designed in such a way that a liquid transfer to and a rising of the liquids in the shaped body (1) is substantially effected by capillary forces.

6. Reactor support as claimed in claim 5, characterized in that the shaped bodies (1) are made of a sintered plastic granulate or a glass granulate or foamed glass or porous silicon, or a ceramics or metal frits, wherein the porosity lies in an order of size of from 5-75%.

7. Reactor support as claimed in one of the claims 1 to 6, characterized in that the mean diameter distribution of the sample particles (3) is greater than the pores of the shaped bodies (1), however, still as small that the rising of the liquid in the packed particles within the shaped body recess 11 is substantially effected by the capillary forces.

8. Reactor support as claimed in one of the claims 1 to 7, characterized in that the volume of the porous shaped body (1) formed by the side walls (14) and by the bottom area (13) is greater than the volume of the recesses (11) inserted into the shaped body (1) and, thus, greater than the entire volume of the particles (3) brought into these recesses.

9. Reactor support as claimed in claim 8, characterized in that the ratio of the volume of the porous shaped body walls to the volume of the recesses (11) lies in an order of size from 1000:1 to 1:1.

10. Reactor support as claimed in one of the claims 1 to 9, characterized in that the side wall ranges (14) of the shaped body (1) are captured by a wall impermeable by liquids.

11. Reactor support as claimed in claim 10, characterized in that the wall impermeable by liquids is formed by a shell (5) inserted into the recess (21) of the plate (2).

12. Reactor support as claimed in one of the preceding claims 1 to 11, characterized in that a cover (8) covers a plurality of shaped bodies (1) arranged in a row.

13. Reactor support as claimed in one of the claims 1 to 11, characterized in that cover (8) covers all the shaped bodies (1) arranged in the plate (2).

14. Reactor support as claimed in claim 12 or 13, characterized in that the cover (8) is formed by a one-sidedly self-adhesive foil.
